(19) United States
(12) Patent Application Publication
(10) Pub. No.: US 2018/0265287 A1
(43) Pub. Date: Sep. 20, 2018

(54) PEDAL OPERATED BIN WITH AN OVERLOAD DAMAGE RESISTANT MECHANISM

(71) Applicant: Evershine Stainless Steel Sdn. Bhd., Semenyih (MY)

(72) Inventor: Boon Hing NG, Semenyih (MY)

(21) Appl. No.: 15/922,518

(22) Filed: Mar. 15, 2018

(30) Foreign Application Priority Data
Mar. 16, 2017 (MY) PI 2017700888

(51) Int. Cl. B65F 1/16; B65D 43/26

(52) U.S. Cl. CPC B65F 1/163; B65F 2001/1692; B65D 43/265; B65D 43/262

(57) ABSTRACT

The invention provides a bin with a pedal operated lid comprising a lever, a pedal for actuating the lever and an operating rod connecting the lever to the lid, for opening the lid when the lever is actuated by a user. The lever is articulated, and selectively adopts a rigid state under normal operating conditions enabling actuation of the operating rod, and a flexed state under abnormal operating conditions that prevents actuation of the operating rod.

### FIELD OF THE INVENTION

The present invention relates to the field of waste or rubbish bins, specifically bins which have a lid which is lifted by a foot-operated pedal.

### BACKGROUND OF THE INVENTION

Rubbish or waste bins with lids or covers which are lifted by a pedal operated mechanism are already well known in the field of technology and have been in widespread use for a number of years.

A rubbish or waste bin with a pedal operated lid typically has a lever with a foot pedal on one end which is generally positioned at the base of the bin for easy reach by a user, and an operating rod connected to the other end of the lever, for lifting the lid when the foot pedal is actuated by a user.

However, since the lids of such bins are generally heavy, improvements have been made to prevent the lid from falling shut when the pedal is released and potentially causing injury to the user. One such improvement has been the addition of a damper device such as a shock absorber to the operating rod to retard the motion of the lid as it falls, when the pedal is released.

Malaysian Patent No. MY-127540-A by the applicant is a good example of a prior art which discloses a bin with features such as that described in the preceding paragraph.

While generally effective, this improvement which relies on the operating rod and the damper device is susceptible to damage due to mis-use, or when the lid is jammed.

For example, since such pedal-operated bins are commonly used as municipal waste bins which are intended for public use, there are situations when there is a heavy load inadvertently placed on or stacked up on the lid of the bin when the bin is full.

Under such circumstances, when an unwitting user steps on the pedal of such a bin to actuate the lever to lift the lid, the damper device may be damaged due to added weight of the load resisting the lifting action of the operating rod.

In addition, the added weight of a heavy load on the lid may also cause the operating rod to bend or break when a user steps on the pedal to use the bin.

In view of the potential damage which may be caused to a pedal operated rubbish or waste bin, it is a stated objective of the present invention to provide a pedal operated bin which is overload damage resistant, that is also simple to manufacture, resilient and rugged, in view of the rough usage that is associated with such bins.

### SUMMARY OF THE INVENTION

In a first aspect, the invention provides a bin with a pedal operated lid comprising a lever, a pedal for actuating the lever and an operating rod connecting the lever to the lid for opening the lid when the lever is actuated by a user.

The lever is articulated, and selectively adopts a rigid state under normal operating conditions enabling actuation of the operating rod, and a flexed state under abnormal operating conditions that prevents actuation of the operating rod.

The operating rod may optionally include a damper device for preventing the lid from slamming shut when the articulated lever is released by the user.

The lever's ability to selectively adopt a rigid state and to adopt a flexed state, allows a bin with a pedal operated lid to function under normal operating conditions, and at the same time prevent the operating rod and/or the damper device from being damaged under abnormal operating conditions.

In the bin with a pedal operated lid according to the first aspect of the invention, the lever may comprise a first arm, a second arm, a pivot shaft, and a biasing means.

The first arm has an outer extremity capable of receiving a pedal and an inner extremity defining a first hinge joint.

The second arm has an outer extremity capable of receiving an operating rod and an inner extremity defining a second hinge joint corresponding to and capable of being pivotally coupled to the first hinge joint.

The pivot shaft passes through the first and second hinge joints to define a hinge between the first and second arms, and to also define the fulcrum of the lever.

The biasing means is positioned about the pivot shaft.

When the biasing means is in an unloaded state, this causes the first arm and the second arm to remain rigid, enabling the lever to actuate the operating rod when the lever is actuated by a user.

When the biasing means in a loaded state, this causes the first arm to pivot relative to the second arm, preventing the lever from actuating the operating rod when the lever is actuated by a user.

The biasing means of the lever may be a torsion spring or a flat spring.

The bin with a pedal operated lid may further comprise a hinge travel limiter between the inner extremity of the first arm and the inner extremity of the second arm to limit the pivotal movement of the first arm relative to the second arm.

Additionally, the hinge travel limiter may also serve to retain the biasing means in place.

The hinge travel limiter means may comprise a pair of slots on the inner extremity of one of the arms of the lever, a pair of through holes on the inner extremity of the other of the arms corresponding to the position of the slots on the first arm, and a retainer shaft passing through the slots and the through holes, and capable of movement within the travel of the slots.

In a second aspect of the invention, an articulated lever for a bin with a pedal operated lid is disclosed, which comprises a first arm, a second arm, a pivot shaft, and a biasing means.

The first arm has an outer extremity capable of receiving a pedal and an inner extremity defining a first hinge joint.

The second arm has an outer extremity capable of receiving an operating rod and an inner extremity defining a second hinge joint corresponding to and capable of being pivotally coupled to the first hinge joint.

The pivot shaft passes through the first and second hinge joints defining a hinge between the first and second arms of the lever, and also defines the fulcrum of the lever.

The biasing means is positioned about the pivot shaft.

In an unloaded state, the biasing means causes the first arm and the second arm to remain rigid, enabling the articulated lever to actuate the operating rod when the articulated lever is actuated by a user.

In a loaded state, the biasing means causes the first arm to pivot relative to the second arm, preventing the articulated lever from actuating the operating rod when the articulated lever is actuated by a user.

The biasing means of the articulated lever may be a torsion spring. As an alternative, the biasing means may instead be a flat spring.

The articulated lever may further comprise a hinge travel limiter between the inner extremity of the first arm and the inner extremity of the second arm to limit the pivotal movement of the first arm of the lever relative to the second arm of the lever.

Additionally, the hinge travel limiter may also serve to retain the biasing means in place.

The hinge travel limiter means may comprise a pair of slots on the inner extremity of one of the arms of the lever, a pair of through holes on the inner extremity of the other of the arms corresponding to the position of the slots on the first arm, and a retainer shaft passing through the slots and the through holes, and capable of movement within the travel of the slots.

The articulated lever according to the second aspect of the invention has the advantage of being versatile, in that its features are easily implemented as a modification of an existing lever, and also as a drop-in or direct replacement for the traditional lever used in pedal operated bins (which are of the non-articulated variety), which has the advantage of introducing the feature of preventing damage to the operating rod and/or the damper device under abnormal operating conditions to existing pedal operated bins by simple retrofit.

### BRIEF DESCRIPTION OF THE DRAWINGS

The invention is illustrated, though not limited by the following description of the embodiments that is being given by way of example only, with reference to the accompanying drawings in which:

FIG. 1 illustrates a perspective view of the articulated lever according to a first embodiment of the invention.

FIG. 2 illustrates an exploded perspective view of the articulated lever according to the first embodiment of the invention illustrated in FIG. 1.

FIG. 3A illustrates a bin with a pedal operated lid incorporating the articulated lever according to the first embodiment of the invention as illustrated in FIG. 1, at rest and under normal operating conditions.

FIG. 3B illustrates a close-up view of the articulated lever at rest and under normal operating conditions, as illustrated in FIG. 3A.

FIG. 4A illustrates a bin with a pedal operated lid incorporating the articulated lever according to the first embodiment of the invention as illustrated in FIG. 1, when actuated and under normal operating conditions.

FIG. 4B illustrates a close-up view of the articulated lever when actuated and under normal operating conditions, as illustrated in FIG. 4A.

FIG. 5A illustrates a bin with a pedal operated lid incorporating the articulated lever according to the first embodiment of the invention as illustrated in FIG. 1, when actuated and under abnormal operating conditions.

FIG. 5B illustrates a close-up view of the articulated lever when actuated and under abnormal operating conditions, as illustrated in FIG. 5A.

FIG. 6 illustrates a perspective view of an articulated lever according to a second embodiment of the invention.

FIG. 7 illustrates an exploded perspective view of the articulated lever according to the second embodiment of the invention illustrated in FIG. 6.

FIG. 8A illustrates a bin with a pedal operated lid incorporating the articulated lever according to the second embodiment of the invention as illustrated in FIG. 6, at rest and under normal operating conditions.

FIG. 8B illustrates a close-up view of the articulated lever as illustrated in FIG. 8A, at rest and under normal operating conditions.

FIG. 9A illustrates a bin with a pedal operated lid incorporating the articulated lever according to the second embodiment of the invention as illustrated in FIG. 6, when actuated and under normal operating conditions.

FIG. 9B illustrates a close-up view of the articulated lever as illustrated in FIG. 9A, when actuated and under normal operating conditions.

FIG. 10A illustrates a bin with a pedal operated lid incorporating the articulated lever according to the second embodiment of the invention as illustrated in FIG. 6, when actuated and under abnormal operating conditions.

FIG. 10B illustrates a close-up view of the articulated lever as illustrated in FIG. 10A, when actuated and under abnormal operating conditions.

### DETAILED DESCRIPTION OF THE EMBODIMENTS

A rubbish or waste bin with a pedal operated lid, as previously explained typically has a lever with a foot pedal on one end which is positioned at the base of the bin, and an operating rod connected to the other end of the lever, for lifting the lid when the foot pedal is actuated by a user.

The lever is typically installed in the base of rubbish or waste bin with a pedal operated lid, since pedal operated rubbish or waste bins are preferably foot operated.

As with a typical rubbish or waste bin with a pedal operated lid, a foot pedal is attached to or formed at one end of the lever, and an operating rod for opening the lid when the lever is actuated by a user is connected to the other end, connecting the lever to the lid.

The operating rod is generally provided with a damper device for damping the fall of the lid and preventing the lid from slamming shut when the user removes his/her foot from the pedal, which releases the lever. It should also be noted that the inclusion of a damper device, although preferable, is not essential.

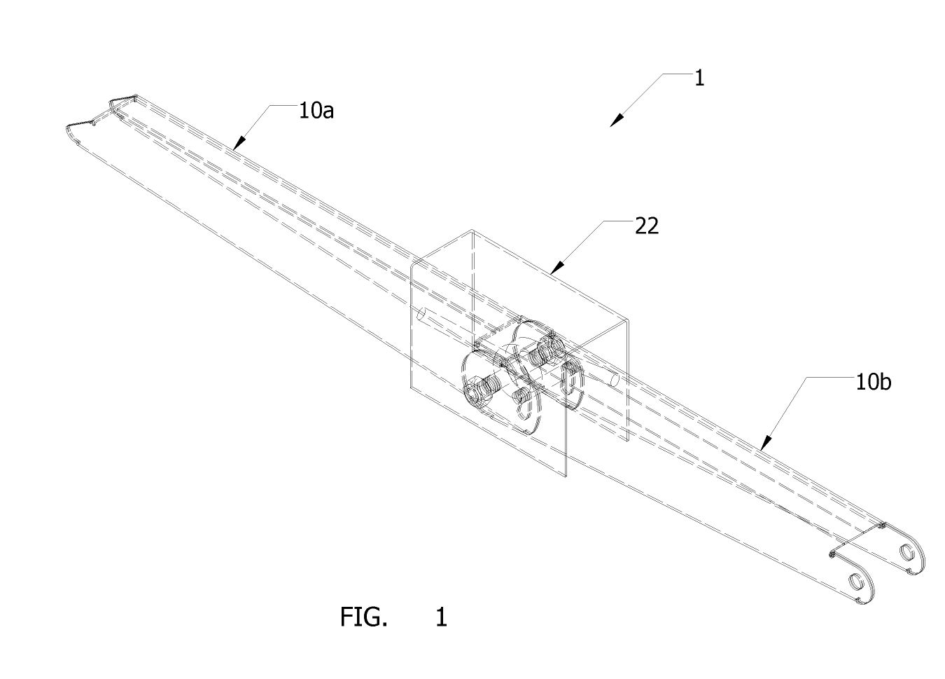

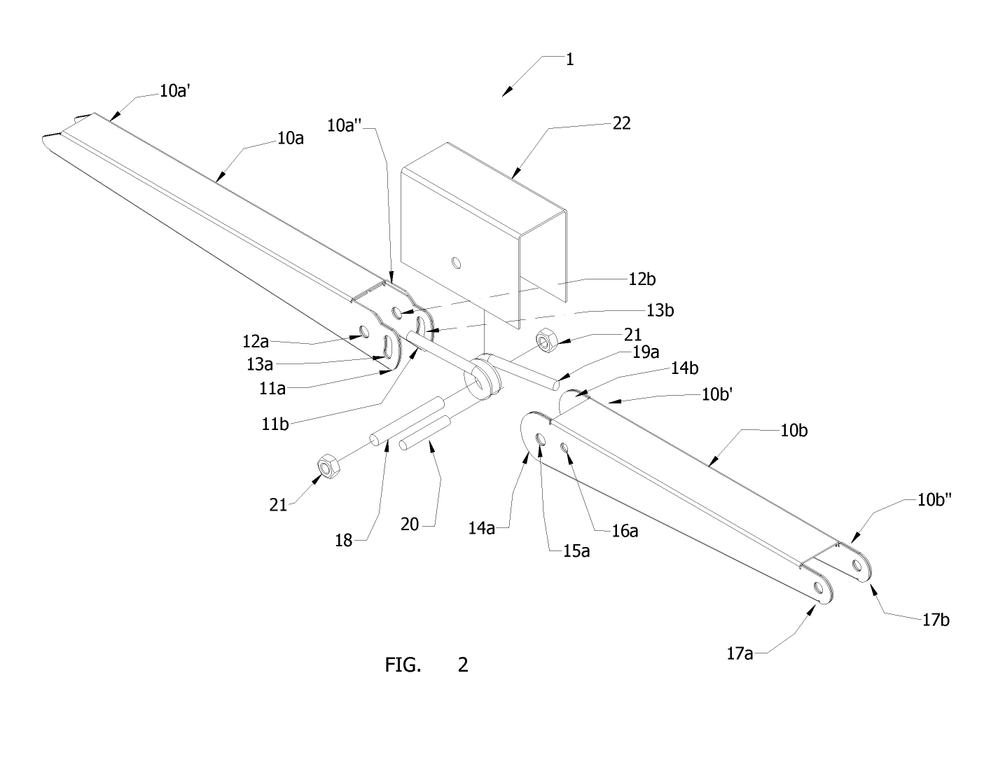

FIGS. 1 and 2 illustrate an articulated lever according to a first embodiment of the invention which is suitable for use in a rubbish or waste bin with a pedal operated lid, as a direct replacement of the traditional lever used.

In FIG. 1, the articulated lever 1 according to the first embodiment of the invention is illustrated in the perspective view. The relationship between each component of the articulated lever when in the assembled state is clearly shown.

In FIG. 2, the articulated lever 1 according to the first embodiment of the invention is illustrated in the perspective view, this time as an exploded view, showing each component separate from the other components for the purpose of clarity, and also how each component of the articulated lever relates to one another.

The articulated lever 1 according to the first embodiment of the invention comprises the following components:
a) a first arm 10a,
b) a second arm 10b,
c) a pivot shaft 18,
d) a torsion spring 19a, and
e) a hinge travel limiter shaft 20.

The first arm 10a has an outer extremity 10a′ and an inner extremity 10a″. The first arm 10a is typically a longitudinal structure with an inverted channel or inverted U-shaped cross-section.

The outer extremity 10a′ of the first arm 10a is capable of receiving a foot pedal 3, which may be attached to the outer extremity of the first arm by welding, or by other attachment means such as bolts or screws.

The inner extremity 10a″ of the first arm 10a includes a pair of projections or ears 11a, 11b on the vertical sides, each with a through-hole 12a, 12b which corresponds to one another, and is capable of receiving a pivot shaft 18, which defines a first hinge joint.

Each projection or ear 11a, 11b on the inner extremity 10a″ of the first arm 10a also includes a slot 13a, 13b which is arc-shaped, and which corresponds to one another, for receiving the hinge travel limiter and torsion spring retainer shaft 20.

The second arm 10b also includes an inner extremity 10b′ and an outer extremity 10b″. As with the first arm 10a, the second arm 10b is also typically a longitudinal structure with a C- or U-shaped cross-section.

The inner extremity 10b′ includes a pair of projections or ears 14a, 14b on the vertical sides, each with a through-hole 15a, 15b which corresponds to one another, and is capable of receiving a pivot shaft 18, which defines a second hinge joint. The second hinge joint corresponds to and is capable of receiving and being pivotally coupled to the first hinge joint.

The inner extremity 10b′ also has a second through-hole 16a, 16b on each vertical side, which corresponds to the position of the slots 13a, 13b on the first arm 10a and which is capable of receiving the hinge travel limiter and torsion spring retainer shaft 20.

The outer extremity 10b″ is capable of receiving an operating rod 2, and also includes a pair of projections or ears 17a, 17b on the vertical sides for securing one end of an operating rod 2.

Both the first arm and the second arm are typically and preferably fabricated from stainless steel plate to afford it a degree of corrosion resistance, in view of the harsh environment expected of municipal facilities.

The pivot shaft 18 corresponds to and passes through the through-holes 12a, 12b, 15a, 15b that define the first and second hinge joints, and serves as both the hinge between the first and second arms 10a, 10b of the lever 1, and the fulcrum of the lever.

In FIGS. 1 and 2, the pivot shaft 18 passing through the articulated lever 1 is secured by a pair of nuts 21 to a mounting bracket 22, which is typically located at the base of a bin 4.

However, it should be noted the articulated lever 1 according to the first embodiment of the present invention is not limited to the mounting bracket 22 illustrated here, and may alternatively be secured by the pivot shaft 18 to any other suitable fixture positioned at the base of a bin 4, as dictated by the bin's design.

The torsion spring 19a is positioned about the pivot shaft 18, and is preferably one with a straight torsion ends configuration.

When the torsion spring 19a is unloaded (i.e., in a state of rest), the spring resists any pivotal movement of the hinge between the first arm 10a and the second arm 10b of the articulated lever.

In this state, the first arm 10a and the second arm 10b remain rigid, enabling the articulated lever 1 to pivot about the fulcrum and actuate the operating rod 2 when the articulated lever is actuated by a user.

When the torsion spring 19a is loaded (i.e., in a twisted state), the torque applied twists the torsion spring and causes the first arm 10a to pivot at the hinge, relative to the second arm 10b.

In this state, the pivoting action of the first arm 10a relative to the second arm 10b flexes the articulated lever 1, preventing it from pivoting at the fulcrum and actuating the operating rod 2 when the articulated lever 1 is actuated by a user.

The hinge travel limiter shaft 20 passes through the slots 13a, 13b on the inner extremity 10a″ of the first arm 10a and the corresponding through-holes 16a, 16b on the inner extremity 10b′ of the second arm 10b.

As its name suggests, the hinge travel limiter shaft 20 serves to limit the pivotal movement of the first arm 10a relative to the second arm 10b, and has the subsidiary function of retaining and securing the torsion spring 19a in place.

The hinge travel limiter shaft 20 is capable of movement within the range of travel of the arc-shaped slots 13a, 13b.

Although present in the first embodiment, the hinge travel limiter shaft 20 is not essential for the working of the articulated lever, and can be omitted altogether if necessary.

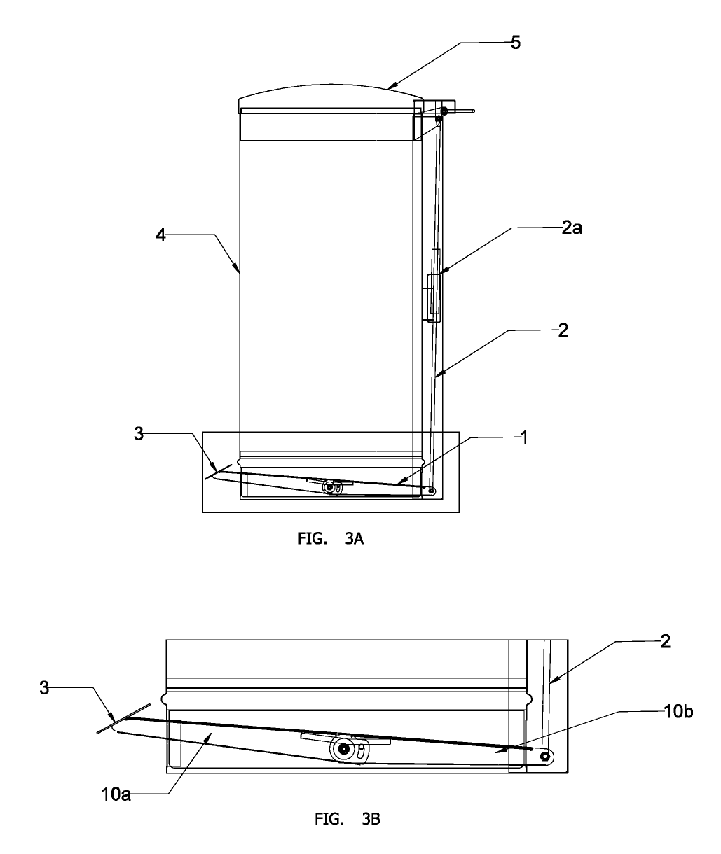

FIG. 3A illustrates a rubbish or waste bin 4 with a pedal operated lid 5 incorporating the articulated lever 1 according to the first embodiment of the invention as illustrated in FIGS. 1 and 2, when it is at rest and under normal operating conditions.

FIG. 3B is a close-up view of the articulated lever 1 when it is at rest and under normal operating conditions, showing the articulated lever illustrated in FIG. 3A in greater clarity.

It should be clarified here, that the term ‘normal operating condition’ as used throughout the specification is taken to mean that the lid of the rubbish or waste bin is unimpeded and free to move when a user depresses the foot pedal to actuate the articulated lever to lift the lid from the bin.

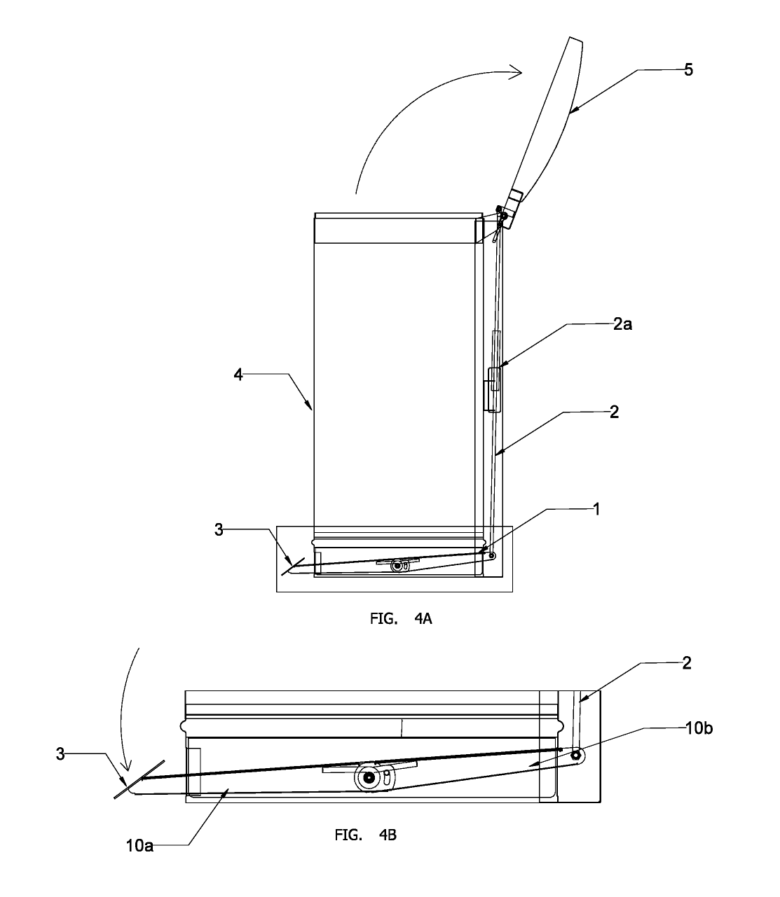

FIG. 4A illustrates a rubbish or waste bin with a pedal operated lid incorporating the articulated lever according to the first embodiment of the invention as illustrated in FIGS. 1 and 2, when it is actuated and under normal operating condition.

FIG. 4B is a close-up view of the articulated lever when it is actuated and under normal operating condition, showing the lever assembly illustrated in FIG. 4A in greater clarity.

Under normal operating condition, the torsion spring 19a is unloaded when a user depresses the foot pedal 3 as can be seen in FIGS. 4A and 4B.

In this condition, the tension of the torsion spring 19a causes the legs 19a′, 19a″ of the torsion spring to each push against first arm 10a and the second arm 10b which resists the lever 1 from pivoting at the hinge, thus enabling the lever to remain rigid.

When the torsion spring 19a is unloaded and the articulated lever 1 is rigid, the articulated lever is able to function normally by pivoting about the pivot shaft 18 (i.e., the fulcrum), thus allowing the control rod 2 to push the lid 5 upwards when the articulated lever 1 is actuated by a user.

Conversely, the term ‘abnormal operating condition’ is taken here to mean that that the lid of the rubbish or waste bin is impeded due to the lid of the bin being obstructed by a heavy load or overloaded, for example, and is unable to move even when a user depresses the foot pedal to actuate the lever assembly to lift the lid from the bin.

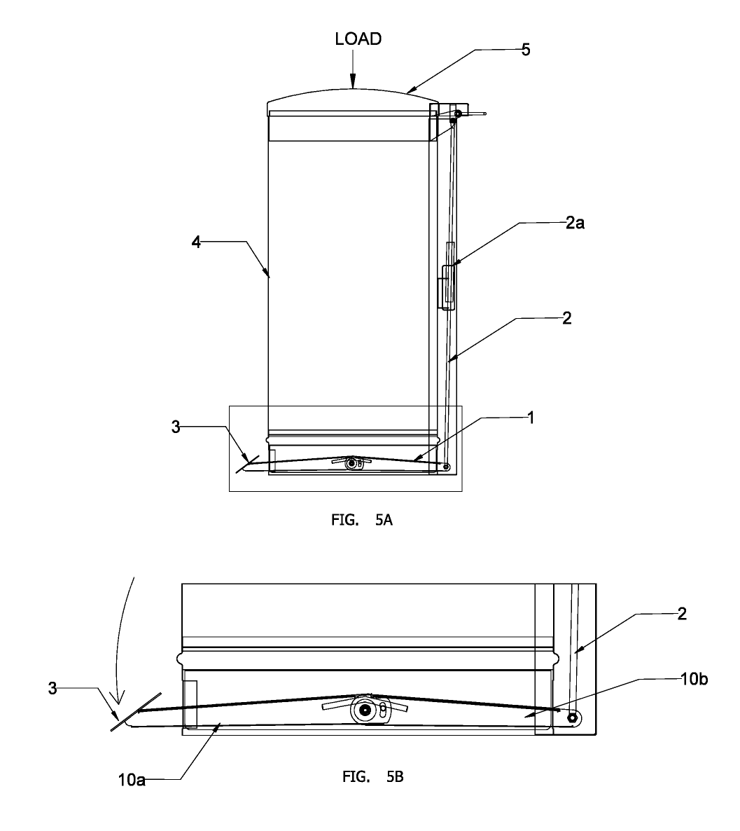

FIG. 5A illustrates a rubbish or waste bin with a pedal operated lid incorporating the articulated lever according to the invention as illustrated in FIGS. 1 and 2, when it is actuated and under abnormal operating conditions.

FIG. 5B is a close-up view of the articulated lever when it is actuated and under abnormal operating conditions, showing the articulated lever illustrated in FIG. 5A in greater clarity.

Under abnormal operating conditions, the torsion spring 19a becomes loaded when a user depresses the foot pedal 3 as can be seen in FIGS. 5A and 5B.

In this condition, the first arm 10a and second arm 10b, both twist and overcome the tension of the torsion spring 19a, pushing downward against the legs 19a′, 19a″ of the torsion spring and causing the articulated lever 1 to pivot at the hinge instead of the pivot shaft (i.e., the fulcrum), thus disabling the articulated lever and preventing the control rod from pushing the lid upwards when the articulated lever 1 is actuated by a user.

When the articulated lever 1 is disabled, the control rod 2 cannot be forced by the articulated lever to push the lid 3 upwards, until the obstruction causing the abnormal operating condition is removed and normal operating condition is restored.

The action of the articulated lever 1 to pivot at the hinge under an abnormal operating condition instead of the fulcrum, thus prevents the control rod 2 from bending or breaking, and/or the damper device 2a of the control rod from being damaged by being forced upwards against the weight of the obstructing load, when a user depresses the foot pedal 3 to actuate the articulated lever 1 to lift the lid 5 from the bin 4.

The articulated lever according to the first embodiment of the invention is not limited to the components used and illustrated in FIGS. 1 and 2, and as described previously. Certainly, modification and variants of the lever assembly using similar components having different configurations may be envisaged without departing from the scope of the invention.

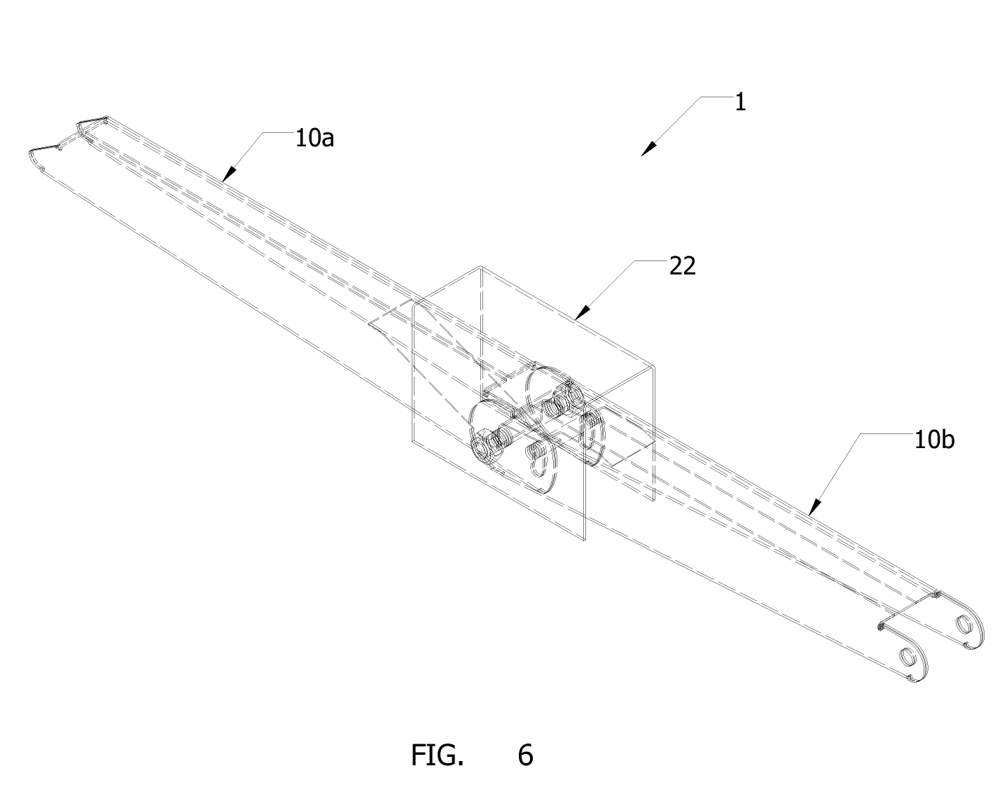

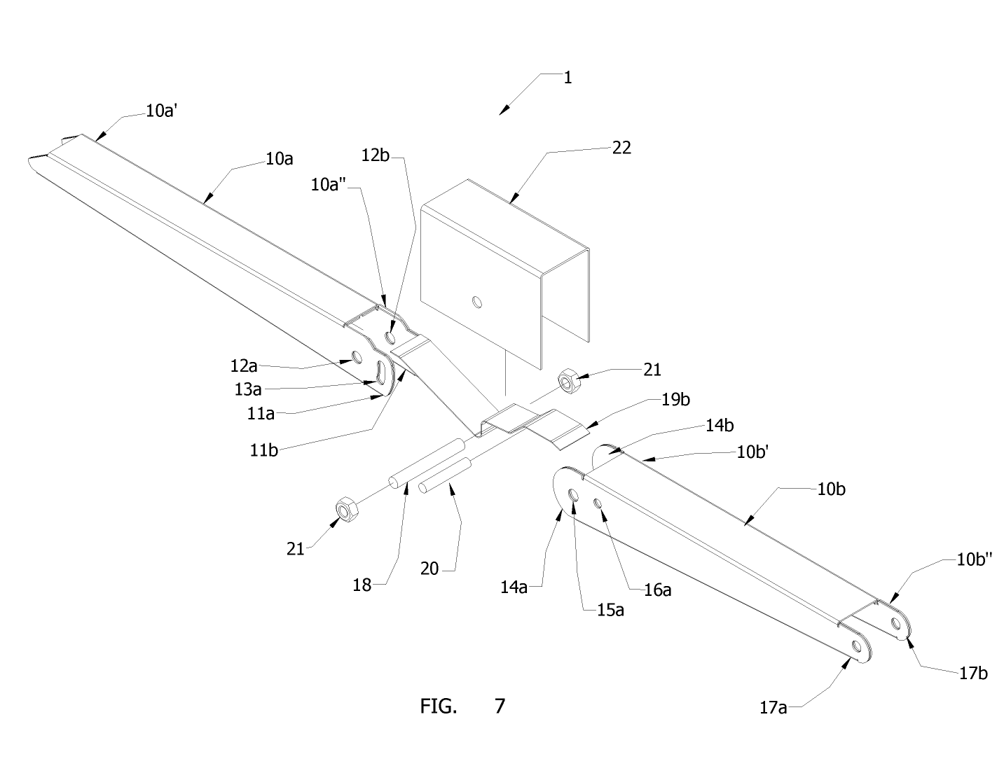

Accordingly, FIGS. 6 and 7 illustrate an articulated lever according to a second embodiment of the invention which is suitable for use in a rubbish or waste bin with a pedal operated lid, as a direct replacement of the traditional lever used.

FIG. 6 illustrates a perspective view of an articulated lever according to the second embodiment of the invention.

FIG. 7 illustrates an exploded perspective view of the articulated lever according to the second embodiment of the invention as illustrated in FIG. 6.

In FIG. 6, the articulated lever according to the second embodiment of the invention is illustrated in the perspective view. The relationship between each component of the articulated lever when in the assembled state is clearly shown.

In FIG. 7, the articulated lever according to the second embodiment of the invention is illustrated in the perspective view, this time as an exploded view, showing each component separate from the other components for the purpose of clarity, and also how each component of the articulated lever relates to one another.

The articulated lever 1 according to the second embodiment of the invention comprises the following components:
a) a first arm 10a,
b) a second arm 10b,
c) a pivot shaft 18,
d) a flat spring 19b, and
e) a hinge travel limiter shaft 20.

In the articulated lever 1 illustrated in FIGS. 6 and 7, a flat spring 19b is used in place of the torsion spring 19a in the articulated lever according to the first embodiment of the invention as illustrated in FIGS. 1 and 2. All other components are similar and unchanged.

The flat spring 19b in the variant of the articulated lever as its name suggests, is essentially a flat strip of flexible, elastic material which has been press formed into a specific shape so that it functions as a spring or a biasing member.

In the variant of the articulated lever 1, the flat spring 19b has two load or tension bearing portions or surfaces 19b′, 19b″ and a fulcrum 19b′″, and is positioned below or under the pivot shaft 18, with a load or tension bearing portion extending into each of the first arm 10a and the second arm 10b of the articulated lever.

When the flat spring 19b is unloaded (i.e., in a state of rest), the flat spring resists pivotal movement of the hinge between the first arm 10a and the second arm 10b of the articulated lever.

In this state, the first arm 10a and the second arm 10b remain rigid, enabling the articulated lever 1 to pivot at the fulcrum and actuate the operating rod 2 when the articulated lever 1 is actuated by a user.

When the flat spring 19b is loaded (i.e., in a deflected or twisted state), it allows the hinge to pivot the first arm 10a relative to the second arm 10b.

In this state, the action of the first arm 10a to pivot relative to the second arm 10b flexes the articulated lever 1, preventing it from pivoting at the fulcrum and actuating the operating rod 2 when the articulated lever 1 is actuated by a user.

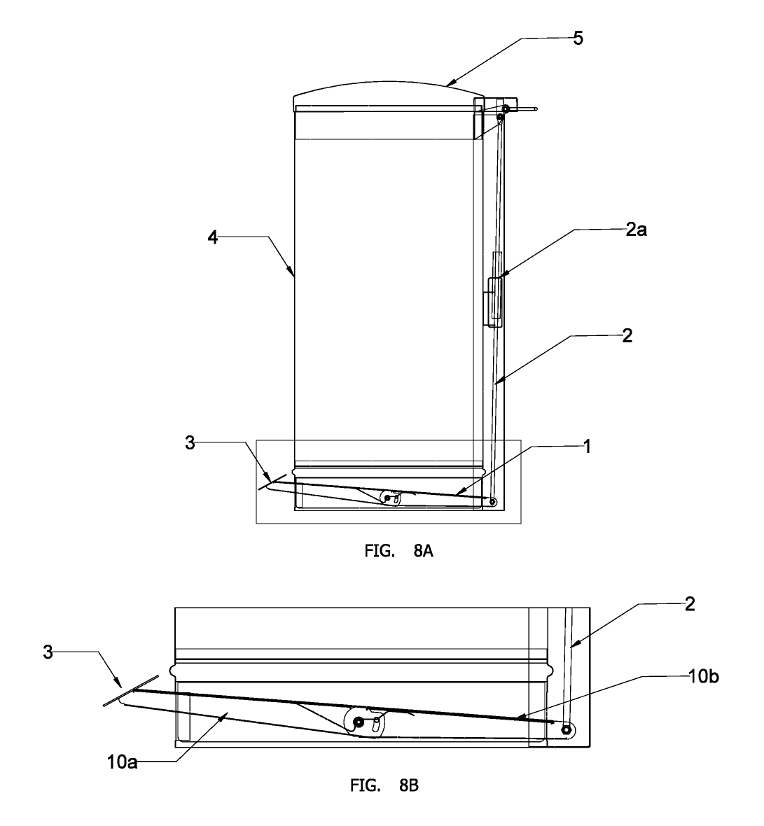

FIG. 8A illustrates a rubbish or waste bin with a pedal operated lid incorporating the articulated lever according to the second embodiment of the invention as illustrated in FIGS. 6 and 7, when it is at rest and under normal operating conditions.

FIG. 8B is a close-up view of the articulated lever when it is at rest and under normal operating conditions, showing the articulated lever illustrated in FIG. 8A in greater clarity.

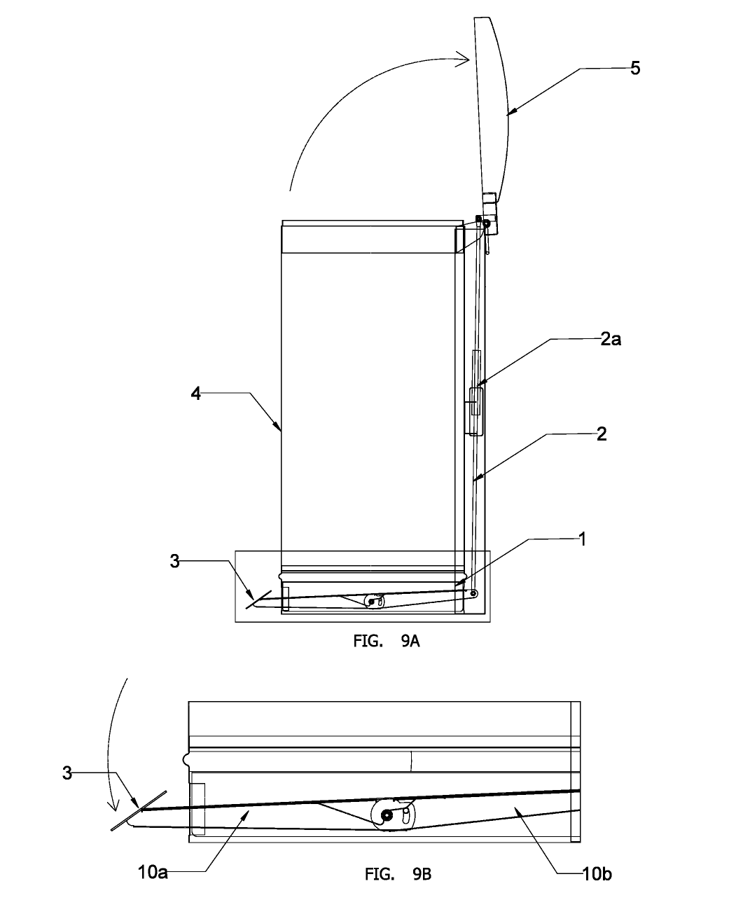

FIG. 9A illustrates a rubbish or waste bin with a pedal operated lid incorporating the articulated lever according to the second embodiment of the invention as illustrated in FIGS. 6 and 7, when it is actuated and under normal operating condition.

FIG. 9B is a close-up view of the articulated lever when it is actuated and under normal operating condition, showing the articulated lever illustrated in FIG. 9A in greater clarity.

Under normal operating condition, the flat spring 19b is unloaded when a user depresses the foot pedal 3 as can be seen in FIGS. 9A and 9B.

In this condition, the tension of the flat spring 19b causes the two load or tension bearing portions 19b′, 19b″ of the flat spring 19b to each push against first arm 10a and the second arm 10b of the articulated lever and resist the articulated lever 1 from pivoting at the hinge, enabling the articulated lever 1 to remain rigid.

When the flat spring 19b is unloaded and the articulated lever 1 is rigid, the articulated lever is able to function normally by pivoting about the pivot shaft 18 (i.e., the fulcrum), thus allowing the control rod 2 to push the lid 6 upwards when the articulated lever 1 is actuated by a user.

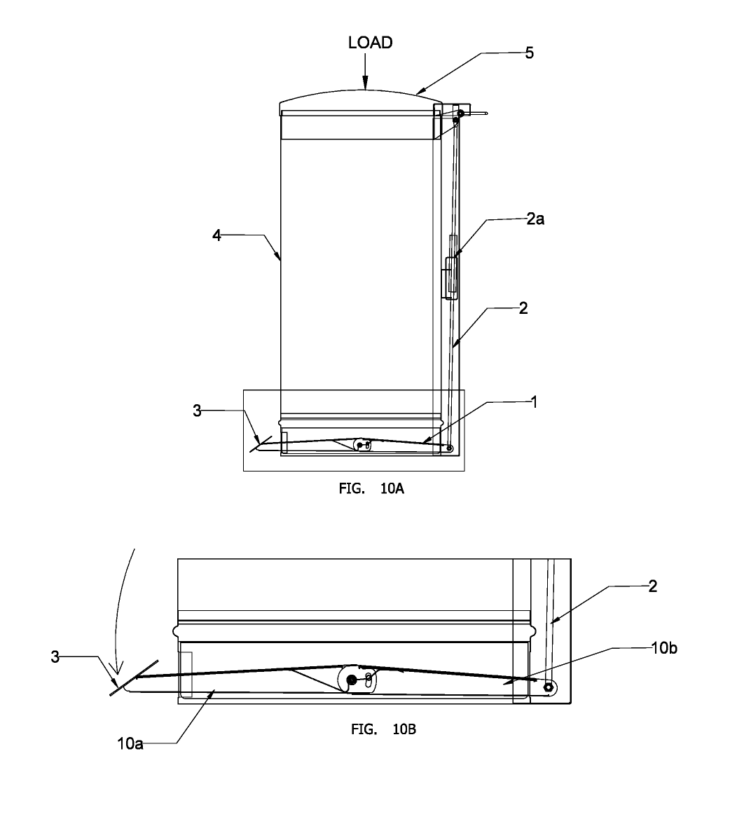

FIG. 10A illustrates a rubbish or waste bin with a pedal operated lid incorporating the articulated lever according to the second embodiment of the invention as illustrated in FIGS. 6 and 7, when it is actuated and under abnormal operating conditions.

FIG. 10B is a close-up view of the articulated lever when it is actuated and under abnormal operating conditions, showing the articulated lever illustrated in FIG. 10A in greater clarity.

Under abnormal operating conditions, the flat spring 19b becomes loaded when a user depresses the foot pedal 3 as can be seen in FIGS. 10A and 10B.

In this condition, the first section 10a and second section 10b both act against the tension of the flat spring 19b and pushes downward against the load or tension bearing portions 19b′, 19b″ of the flat spring. When the tension of the flat spring is overcome, this causes the articulated lever 1 to pivot at the hinge instead of the pivot shaft (i.e., the fulcrum), thus disabling the articulated lever 1 and preventing the control rod 2 from pushing the lid 5 upwards when the articulated lever 1 is actuated by a user.

When the articulated lever 1 is disabled, the control rod 2 cannot be forced by the articulated lever to push the lid 5 upwards, until the obstruction causing the abnormal operating condition is removed and normal operating condition is restored.

Again, the action of the articulated lever 1 to pivot at the hinge under an abnormal operating condition instead of the pivot shaft (i.e., the fulcrum), prevents the control rod 2 from bending or breaking, and/or the damper device of the control rod from being damaged by being forced upwards against the weight of the obstructing load, when a user depresses the foot pedal 3 to actuate the lever assembly to lift the lid 5 from the bin 4.

The present invention is not limited to the embodiments described here, as the description serves only to exemplify the invention and further modifications are readily apparent without departing from the scope of the invention.

1. A bin with a pedal operated lid comprising:
a lever;
a pedal for actuating the lever;
an operating rod connecting the lever to the lid, for opening the lid when the lever is actuated by a user;
characterized in that:
the lever is articulated and selectively adopts:
a) a rigid state under normal operating conditions enabling actuation of the operating rod, and
b) a flexed state under abnormal operating conditions that prevents actuation of the operating rod.

2. The bin with a pedal operated lid according to claim 1, wherein the lever comprises:
a first arm having an outer extremity capable of receiving the pedal and an inner extremity defining a first hinge joint;
a second arm having an outer extremity capable of receiving the operating rod and an inner extremity defining a second hinge joint corresponding to and capable of being pivotally coupled to the first hinge joint;
a pivot shaft passing through the first and second hinge joints defining a hinge between the first and second arms, wherein the pivot shaft also defines the fulcrum of the lever; and
a biasing means positioned about the pivot shaft,
wherein, the biasing means in an unloaded state causes the first arm and the second arm to remain rigid, enabling the lever to actuate the operating rod when the lever is actuated by a user, and
wherein, the biasing means in a loaded state causes the first arm to pivot relative to the second arm, preventing the lever from actuating the operating rod when the lever is actuated by a user.

3. The bin with a pedal operated lid according to claim 2, wherein the biasing means is a torsion spring.

4. The bin with a pedal operated lid according to claim 2, wherein the biasing means is a flat spring.

5. The bin with a pedal operated lid according to claim 2, further comprising a hinge travel limiter between the inner extremity of the first arm and the inner extremity of the second arm to limit the pivotal movement of the first arm relative to the second arm.

6. The bin with a pedal operated lid according to claim 5, wherein the hinge travel limiter further retains the biasing means in place.

7. The bin with a pedal operated lid according to claim 5, wherein the hinge travel limiter comprises a pair of slots on the inner extremity of one of the arms of the lever, a pair of through holes on the inner extremity of the other of the arms of the lever corresponding to the position of the slots, and a retainer shaft passing through the slots and the through holes, and capable of movement within the travel of the slots.

8. The bin with a pedal operated lid according to claim 1, wherein the operating rod includes a damper device for preventing the lid from slamming shut when the lever is released by the user.

9. An articulated lever for a bin with a pedal operated lid comprising:
a first arm having an outer extremity capable of receiving a pedal and an inner extremity defining a first hinge joint;
a second arm having an outer extremity capable of receiving an operating rod and an inner extremity defining a second hinge joint corresponding to and capable of being pivotally coupled to the first hinge joint;
a pivot shaft passing through the first and second hinge joints defining a hinge between the first and second arms, wherein the pivot shaft also defines the fulcrum of the lever;
a biasing means positioned about the pivot shaft,
wherein, the biasing means in an unloaded state causes the first arm and the second arm to remain rigid, enabling the articulated lever to actuate the operating rod when the articulated lever is actuated by a user, and
wherein, the biasing means in a loaded state causes the first arm to pivot relative to the second arm, preventing the articulated lever from actuating the operating rod when the articulated lever is actuated by a user.

10. The articulated lever according to claim 9, wherein the biasing means is a torsion spring.

11. The articulated lever according to claim 9, wherein the biasing means is a flat spring.

12. The articulated lever according to claim 9, further comprising a hinge travel limiter between the inner extremity of the first arm and the inner extremity of the second arm to limit the pivotal movement of the first arm relative to the second arm.

13. The articulated lever according to claim 12, wherein the hinge travel limiter further retains the biasing means in place.

14. The articulated lever according to claim 12, wherein the hinge travel limiter comprises a pair of slots on the inner extremity of one of the arms of the lever, a pair of through holes on the inner extremity of the other of the arms of the lever corresponding to the position of the slots, and a retainer shaft passing through the slots and the through holes, and capable of movement within the travel of the slots.
